(19) United States
(12) Patent Application Publication
(10) Pub. No.: US 2009/0237050 A1
(43) Pub. Date: Sep. 24, 2009

(54) Switching power supply

(75) Inventors: Michiya Yamada, Tokyo (JP); Yukihiro Nishikawa, Tokyo (JP)

Correspondence Address: RABIN & Berdo, PC, 1101 14TH STREET, NW, SUITE 500, WASHINGTON, DC, 20005, US

(73) Assignee: Fuji Electric Device Co., Ltd., Tokyo (JP)

(21) Appl. No.: 12/382,252

(22) Filed: Mar. 11, 2009

(30) Foreign Application Priority Data
Mar. 19, 2008 (JP) 2008-070781

(51) Int. Cl. G05F 1/10

(52) U.S. Cl. 323/282

(57) ABSTRACT

A switching power supply, which operates intermittently under a light load for suppressing electric power consumption, reduces output voltage variations caused when a load current increases rapidly from a light load state, and reduces output voltage ringing. The switching power supply includes a comparator that compares a feedback signal obtained by isolating the output from an error amplifier with a burst threshold value and a comparator that compares the feedback signal with a power-supply-interruption threshold value preset to be lower than the burst threshold value. The switching power supply stops output of a driving pulse from a driver circuit when the feedback signal is lower than the burst threshold value. The switching power supply also stops the output of operation power from first power supply circuit when the feedback signal is lower than the power-supply-interruption threshold value.

### FIELD OF THE INVENTION

The invention relates to a switching power supply that operates intermittently under a light load and stops the operation of the control circuit during a period during which switching is stopped for reducing the power consumption therein.

### BACKGROUND

It has been required for the switching power supply apparatuses to exhibit a high conversion efficiency, to cause less noise, to be small in size, to be manufactured with less manufacturing costs, and to be very reliable. To meet these requirements, various circuit configurations have been proposed.

FIG. 7 is a block diagram of a conventional switching power supply. The switching power supply shown in FIG. 7 is equivalent to the switching power supply described in FIG. 4 in Japanese Unexamined Patent Application Publication No. 2005-006386 (FIG. 4 and the description with reference to FIG. 4).

Referring now to FIG. 7, switching power supply 1 generates, from the DC output of input power supply 2, a DC output different from the DC output of input power supply 2 and feeds the generated DC output to load 3. Switching power supply 1 is a so-called isolated DC-DC converter.

The positive side terminal of input power supply 2 is connected to the first end of primary winding Np1 in transformer 121. The second end of primary winding Np1 is connected to the drain of MOSFET 110. The source of MOSFET 110 is connected to the negative side terminal of input power supply 2. Both ends of secondary winding Ns in transformer 121 are connected to the input of secondary-side main circuit 122. The output from secondary-side main circuit 122 is connected to load 3 and error amplifier 123.

Error amplifier 123 houses therein a circuit that generates a preset voltage set therein in advance. Error amplifier 123 amplifies the error between the output voltage from secondary-side main circuit 122 (hereinafter referred to simply as the “output voltage”) and the preset voltage and outputs the amplified error as a feedback signal.

Switching power supply 1 employs photocoupler 108 for a signal transmitter. The feedback signal outputted from error amplifier 123 is isolated by photocoupler 108 and transmitted to pulse width modulation control circuit (hereinafter referred to as “PWM control circuit”) 102 as feedback signal Vfb.

PWM control circuit 102 houses therein soft start control circuit 112. As operation power is fed, or supplied, to PWM control circuit 102, soft start control circuit 112 conducts soft start control.

PWM control circuit 102 determines the gate pulse width for driving MOSFET 110 based on feedback signal Vfb and feeds a gate pulse signal to driver circuit 101. In response to the gate pulse signal fed from PWM control circuit 102, driver circuit 101 feeds a gate pulse to MOSFET 110 for driving MOSFET 110.

Switching power supply 1 further includes first comparator circuit 105 and first reference voltage supply 106. First reference voltage supply 106 outputs a first reference voltage value (hereinafter referred to sometimes as a “burst threshold value”) Vth1. First comparator circuit 105 compares feedback signal Vfb and burst threshold value Vth1 and feeds the result of the comparison to PWM control circuit 102 and first power supply circuit 103. As feedback signal Vfb exceeds burst threshold value Vth1 to the smaller side, PWM control circuit 102 stops the switching operation that feeds the gate pulse signal to driver circuit 101 and first power supply circuit 103 stops feeding the operation power to PWM control circuit 102.

Now the operations conducted under a light load by the circuit shown in FIG. 7 will be described with reference to FIG. 8.

In FIG. 8, feedback signal Vfb, that is a voltage signal, fed from error amplifier 123 to PWM control circuit 102, operation power supply voltage Vref fed from first power supply circuit 103 to PWM control circuit 102, and gate pulse Vgs fed from driver circuit 101 to the gate of MOSFET 110 are described.

Under a light load and in a period T1, for which feedback signal Vfb is higher than burst threshold value Vth1, PWM control circuit 102 conducts switching operation by the operation power fed thereto from first power supply circuit 103. Under a light load and in a period T2, for which feedback signal Vfb is lower than burst threshold value Vth1, PWM control circuit 102 stops the switching operation and, therefore, the operation power feed from first power supply circuit 103 to PWM control circuit 102 is also stopped.

As described above, switching power supply 1 conducts burst mode of operations under a light load. In the period, for which switching power supply 1 stops the switching operation, switching power supply 1 stops the operation power feed from first power supply circuit 103 to PWM control circuit 102 for greatly reducing the total electric power consumption in switching power supply 1.

However, it is impossible for the PWM control circuit in FIG. 7 to resume (start) the switching operation immediately after the operation power is fed thereto. Therefore, if the load current increases rapidly in a period, for which the operation power feed to the PWM control circuit is stopped, the output voltage will fall before the PWM control circuit resumes the switching operation. (Hereinafter, the period, for which the operation power feed to the PWM control circuit is stopped, will be referred to as the “OFF-period”.) Moreover, the output voltage will cause ringing due to the reasons described later after the PWM control circuit resumes the switching operation. As a result, the voltage fed to the load changes greatly. The greatly changing voltage affects the IC and such electronic component parts in the load adversely, causing malfunctions of the IC and such electronic component parts in the load.

Now the problems described above will be described more in detail below with reference to FIG. 9. FIG. 9 is a wave chart describing the operations of the circuit shown in FIG. 7 when the PWM control circuit is in the OFF-state and load current I_{O} increases rapidly.

In FIG. 9, load current I_{O} and output voltage V_{O} are described. Load I_{O} flows from secondary-side main circuit 122 to load 3. Output voltage V_{O} is outputted (fed) from secondary-side main circuit 122. In FIG. 9, feedback signal Vfb fed from error amplifier 123 to PWM control circuit 102, operation power supply voltage Vref fed from first power supply circuit 103 to PWM control circuit 102, and gate pulse Vgs fed from driver circuit 101 to the gate of MOSFET 110 are also described in the same manner as in FIG. 8.

As load current I_{O} increases at a time t1 in FIG. 9, output voltage V_{O} starts falling. In response to the fall of output voltage V_{O}, feedback signal Vfb starts increasing. As feedback signal Vfb exceeds burst threshold value Vth1 to the higher side at a time t2, first power supply circuit 103 starts feeding operation power to PWM control circuit 102. However, operation power supply voltage Vref is not stabilized so soon at a certain voltage. After operation power supply voltage Vref is stabilized, PWM control circuit 102 initializes the internal logic circuit and finally resumes the switching operation at a time t3. (Hereinafter the operation between the start of the operation power feed and the logic circuit initialization will be referred to as the “restart”.) However, output voltage V_{O} falls greatly during the restart of PWM control circuit 102.

Soft start control circuit 112 in PWM control circuit 102 operates linking with operation power supply voltage Vref that first power supply circuit 103 feeds. Even if operation power supply voltage Vref rises and PWM control circuit 102 resumes the switching operation, the control that does not widen the gate pulse width will be conducted for a while by soft start control circuit 112. Since a sufficient current is not fed to the secondary side due to the above-described control conducted by soft start control circuit 112, output voltage V_{O} further falls.

To make matters worse, as the soft start control conducted by soft start control circuit 112 ends, PWM control circuit 102 raises output voltage V_{O} rapidly for controlling output voltage V_{O} at the set value in a hurry. Since feedback signal Vfb delays reacting to the rapid rise of output voltage V_{O}, output voltage V_{O} exceeds the set voltage to the higher side (hereinafter referred to as “overshooting”).

Feedback signal Vfb delays reacting to the overshooting described above, falling rapidly. As feedback signal Vfb exceeds burst threshold value Vth1 to the lower side, PWM control circuit 102 is brought into the OFF-state thereof (at a time t4). Even if output voltage V_{O} falls later and feedback signal Vfb exceeds burst threshold value Vth1 to the higher side again (at a time t5), it will be impossible to resume the switching operation until the restart of PWM control circuit 102 is finished. Therefore, output voltage V_{O} falls again during the restart.

Although PWM control circuit 102 resumes the switching operation later at a time t6, the soft start control is conducted again, making output voltage V_{O} further fall. After the soft start control is finished, PWM control circuit 102 tries to set output voltage V_{O} at the reference value as soon as possible, causing overshooting (at a time t7).

As described above, output voltage V_{O} causes ringing, in which output voltage V_{O} repeats overshooting and falling and slowly converses to the preset voltage value.

In view of the foregoing, it would be desirable to obviate the problems described above. It would be also desirable to provide a switching power supply that facilitates preventing the electric power consumption under a light load from increasing, suppressing the output voltage fall, caused when the load current increases rapidly from the light load state, as much as possible, and reducing the output voltage ringing.

### SUMMARY OF THE INVENTION

According to a first objective, there is provided a switching power supply of an isolated type, the switching power supply generating a stabilized DC output from a DC output of a DC power supply, the switching power supply including: an error amplifier for amplifying the error between the voltage of the stabilized DC output and a preset voltage;a signal transmitter for isolating the output signal from the error amplifier for forming a feedback signal, the signal transmitter transmitting the feedback signal to a control circuit; and a control power supply for supplying power to a control circuit, the control circuit including a main switching device, a control section for controlling the ON and OFF switching of the main switching device in response to the feedback signal, a driver section for driving the main switching device in response to the output from the control section and stopping the driving when the first comparator section detects the feedback signal decreasing below the first reference voltage value, a first comparator section for comparing the feedback signal with a first reference voltage value, a second comparator section for comparing the feedback signal with a second reference voltage value lower than the first reference voltage value, and a first power supply section supplied with operation power from the control power supply, the first power supply section feeding operation power to a constituent element in the control section and stopping the feeding the operation power when the second comparator section detects the feedback signal decreasing below the second reference voltage value.

According to a second objective, there is provided a switching power supply of a non-isolated_type, the switching power supply generating a stabilized DC output from a DC output of a DC power supply, the switching power supply including an error amplifier for amplifying an error between the voltage of the stabilized DC output and a preset voltage, and outputting the amplified error to a control circuit as a feedback signal, and a control power supply for supplying power to the control circuit, the control circuit including a main switching device, a control section for controlling ON and OFF switching of the main switching device in response to the feedback signal, a driver section for driving the main switching device in response to the output from the control section and stopping the driving when the first comparator section detects the feedback signal decreasing below the first reference voltage value, a first comparator section for comparing the feedback signal with a first reference voltage value, a second comparator section for comparing the feedback signal with a second reference voltage value lower than the first reference voltage value, a first power supply section supplied with operation power from the control power supply, the first power supply section feeding operation power to a constituent element in the control section and stopping the feeding the operation power when the second comparator section detects the feedback signal decreasing below the second reference voltage value.

Advantageously, the switching power supply further includes a second power supply section that feeds operation power to the signal transmitter.

Advantageously, the first power supply section feeds operation power to the first comparator section. Advantageously, the control section includes a soft start control circuit fed with operation power from the control power supply, and the soft start control circuit is made to work only when DC power is fed at or before startup to the switching power supply.

According to the invention, the first reference voltage value for stopping the switching operation and the second reference voltage value for stopping the electric power feed to the PWM control circuit are set individually. According to the invention, the second reference voltage value is set to be lower than the first reference voltage value. The reference voltage setting described above makes the PWM control circuit resume the switching operation thereof quickly even when the load current increases rapidly in the OFF-state of the PWM control circuit. Therefore, the output voltage is prevented from falling. Further, the output voltage ringing caused in the conventional switching power supply in association with the rapid increase of the load current is reduced by the switching power supply according to the invention.

### BRIEF DESCRIPTIONS OF THE DRAWINGS

FIG. 1 is a block diagram of a switching power supply according to a first embodiment of the invention.

FIG. 2 is a wave chart describing the operations of the switching power supply shown in FIG. 1 under a light load.

FIG. 3 is a wave chart describing the operations of the switching power supply shown in FIG. 1 in a state in which the load current increases rapidly.

FIG. 4 is a block diagram of a switching power supply according to a second embodiment of the invention.

FIG. 5 is a block diagram of a switching power supply according to a third embodiment of the invention.

FIG. 6 is a block diagram of a switching power supply according to a fourth embodiment of the invention.

FIG. 7 is a block diagram of a conventional switching power supply.

FIG. 8 is a wave chart describing the operations of the circuit shown in FIG. 7 under a light load.

FIG. 9 is a wave chart describing the operations of the circuit shown in FIG. 7 when the PWM control circuit is in the OFF-state and the load current increases rapidly.

### DESCRIPTION OF THE PREFERRED EMBODIMENTS

Now the invention will be described in detail hereinafter with reference to the accompanied drawings which illustrate the preferred embodiments of the invention.

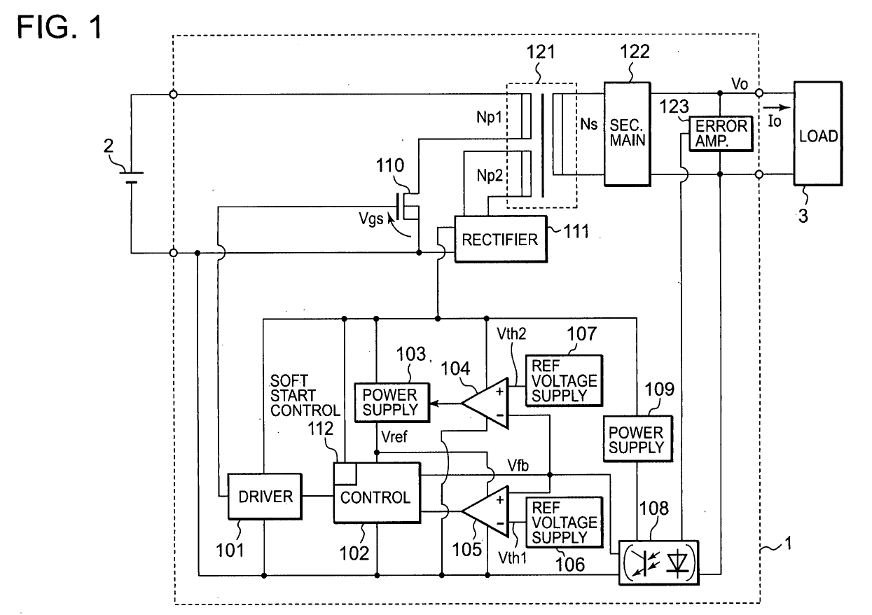

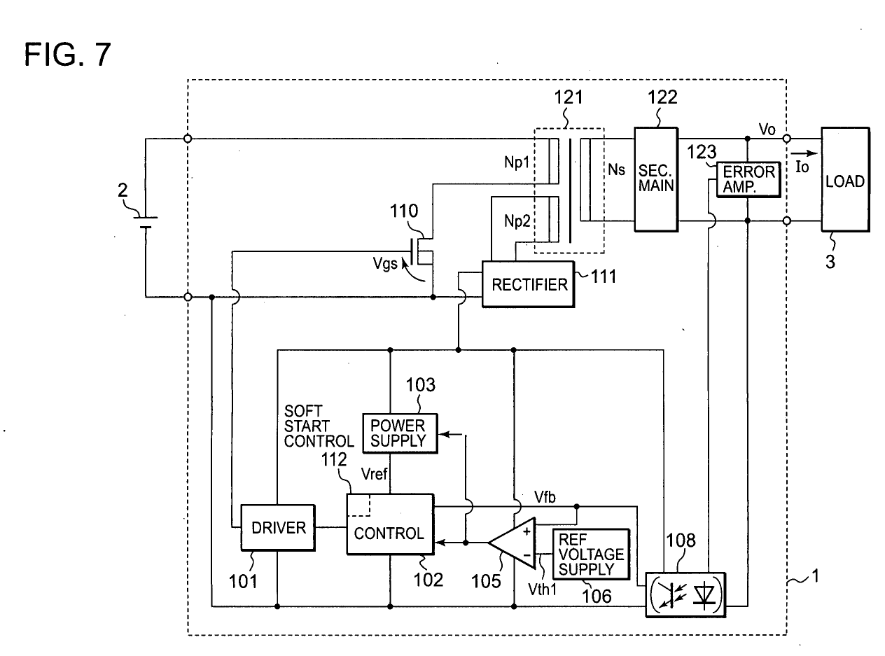

FIG. 1 is a block diagram of a switching power supply according to a first embodiment of the invention. The same reference numerals as used in FIG. 7 are used to designate the same constituent elements and their duplicated descriptions are omitted for the sake of simplicity.

The switching power supply shown in FIG. 1 includes second power supply circuit 109 and second reference voltage supply 107 added to the constituent elements of the switching power supply shown in FIG. 7. In the switching power supply shown in FIG. 1, a path, through which a result of comparison is transferred from second comparator 104 to first power supply circuit 103, is added. The switching power supply shown in FIG. 1 is different from the conventional switching power supply shown in FIG. 7 also in that a current is fed from second power supply circuit 109 to photocoupler 108.

The switching power supply shown in FIG. 1 is configured such that the operation power of soft start control circuit 112 in PWM control circuit 102 is fed from rectifier circuit 111. Due to the configuration described above, operation power will be fed to soft start control circuit 112, even if PWM control circuit 102 is in the OFF-state thereof. Since it is not necessary for PWM control circuit 102 to initialize the internal logic circuit thereof at the restart, a soft start control is prevented from causing after the restart of PWM control circuit 102 and the soft start control is conducted only when input power supply 2 is connected at or before startup to the switching power supply.

First comparator 105 compares burst threshold value Vth1 fed from first reference voltage supply 106 and feedback signal Vfb and feeds the comparison result to PWM control circuit 102. PWM control circuit 102 stops the switching operation thereof as feedback signal Vfb exceeds burst threshold value Vth1 to the lower side.

Second comparator 104 compares second reference voltage value (hereinafter referred to as “power-supply-interruption threshold value”) Vth2 fed from second reference voltage supply 107 and feedback signal Vfb and feeds the comparison result to first power supply circuit 103. As feedback signal Vfb exceeds power-supply-interruption threshold value Vth2 to the lower side, first power supply circuit 103 stops feeding the operation power to PWM control circuit 102 to bring PWM control circuit 102 into the OFF-state thereof.

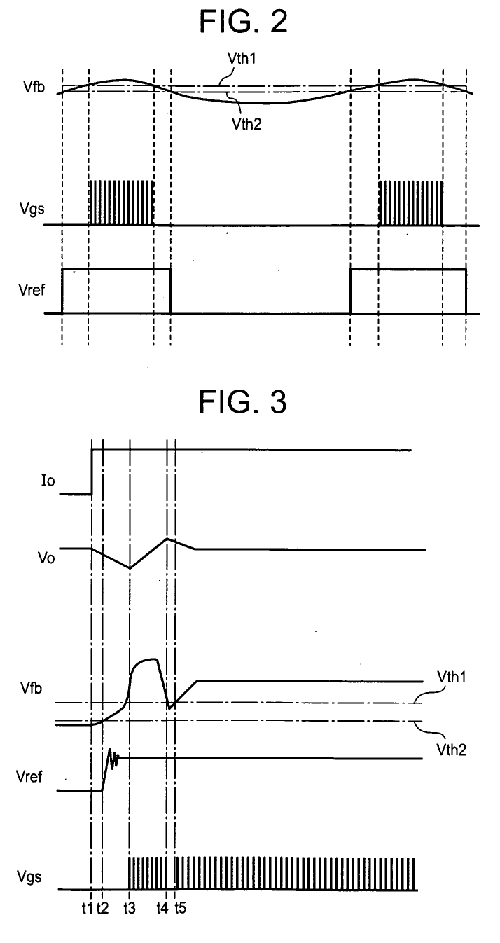

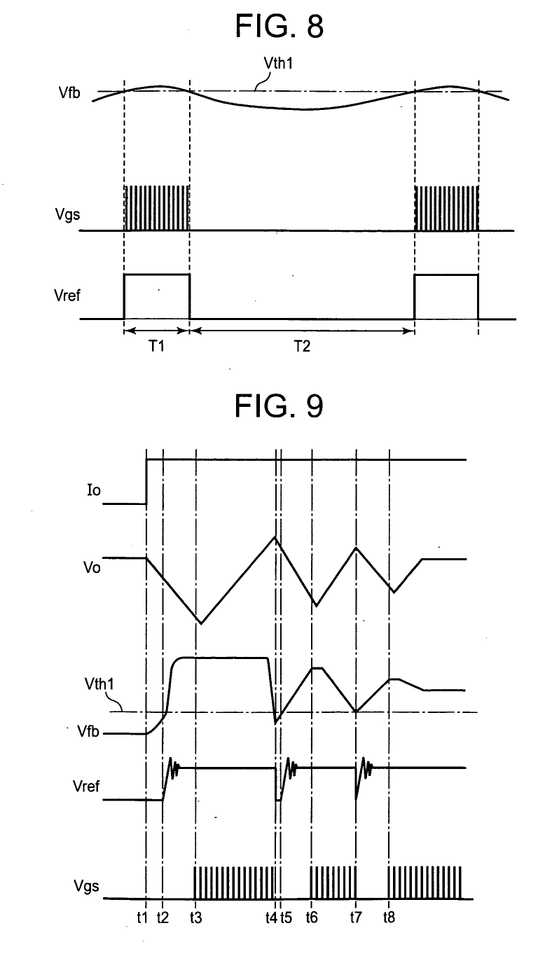

Now the operations of the switching power supply shown in FIG. 1 under a light load will be described with reference to FIG. 2. The same reference symbols as used in FIG. 8 are used to designate the same signals in FIG. 2 and their duplicated descriptions will not be made for the sake of simplicity.

As feedback signal Vfb lowers under a light load and exceeds burst threshold value Vth1 to the lower side, PWM control circuit 102 stops the switching operation thereof. At this stage, however, first power supply circuit 103 keeps feeding operation power to PWM control circuit 102.

As feedback signal Vfb reduces further and exceeds power-supply-interruption threshold value Vth2 to the lower side, PWM control circuit 102 is brought into the OFF-state thereof.

As feedback signal Vfb turns to rising later and exceeds power-supply-interruption threshold value Vth2 to the higher side, PWM control circuit 102 restarts. As feedback signal Vfb further rises and exceeds burst threshold value Vth1 to the higher side, PWM control circuit 102 resumes the switching operation thereof.

Now the operations of the switching power supply shown in FIG. 1 in the state, in which the current of the load that has been light increases rapidly, will be described with reference to FIG. 3. The same reference symbols as used in FIG. 2 are used to designate the same signals in FIG. 3 and their duplicated descriptions will not be made for the sake of simplicity.

As load current I_{O} increases at a time t1 in FIG. 3, output voltage V_{O} starts falling. In response to the fall of output voltage V_{O}, feedback signal Vfb increases. As feedback signal Vfb exceeds power-supply-interruption threshold value Vth2 to the higher side (at a time t2), operation power is fed from first power supply circuit 103 to PWM control circuit 102 and PWM control circuit 102 restarts.

Feedback signal Vfb further increases and exceeds burst threshold value Vth1 to the higher side at a time t3. Since PWM control circuit 102 has already finished the restart thereof, PWM control circuit 102 resumes the switching operation thereof immediately after the time t3. Since the soft start control inside PWM control circuit 102 is prevented from working, PWM control circuit 102 can widen the gate pulse width quickly after resuming the switching operation thereof.

Through the operations described above, the switching power supply according to the first embodiment resumes the switching operations thereof more quickly than the conventional switching power supply and facilitates widening the gate pulse width for minimizing the fall of output voltage V_{O}.

If output voltage V_{O} overshoots at a time t4, the switching operation will be stopped as soon as feedback signal Vfb exceeds burst threshold value Vth1 to the lower side. However, since feedback signal Vfb is still higher than power-supply-interruption threshold value Vth2, PWM control circuit 102 is not brought into the OFF-state thereof. Therefore, as output voltage V_{O} starts lowering, PWM control circuit 102 resumes the switching operation thereof soon (at a time t5) and stabilizes output voltage V_{O} at the set value thereof.

Through the operations described above, the output voltage ringing caused in the conventional switching power supply is reduced. Although the operation power of soft start control circuit 112 is fed from rectifier circuit 111 in FIG. 1, the operation power of soft start control circuit 112 may be fed from second power supply circuit 109 with no problem. A pulse amplitude modulation (PAM) control circuit or a pulse frequency modulation (PFM) control circuit may be employed in substitution for PWM control circuit 102 in FIG. 1 with no problem. Due to the reasons described below, photocoupler 108 is driven by second power supply circuit 109.

If the operation power of photocoupler 108 is fed from rectifier circuit 111, feedback signal Vfb will vary by the fed voltage variations and output voltage ringing will be caused more badly. Thus, the intended effects will not be obtained. In detail, as the drive pulse output is resumed, the output voltage from rectifier circuit 111 rises and, in association with this, feedback signal Vfb also rises. As a result, PWM control circuit 102 further widens the gate pulse width, causing overshooting in the output voltage. The overshooting further causes ringing in the same manner as described with reference to FIG. 9. For preventing the overshooting from causing and further for preventing the ringing from causing, a constant voltage is fed from second power supply circuit 109 to photocoupler 108.

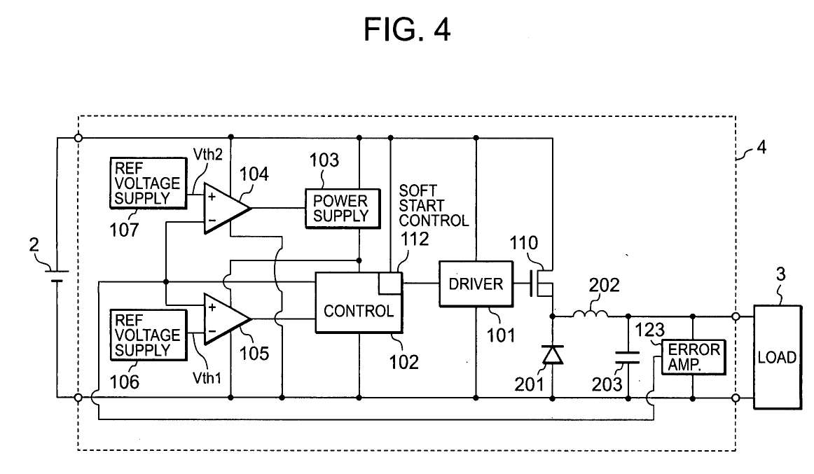

FIG. 4 is a block diagram of a switching power supply according to a second embodiment of the invention. The non-isolated_switching power supply shown in FIG. 4 realizes the same operations same with the operations conducted by the switching power supply shown in FIG. 1. The same reference numerals as used in FIG. 1 are used to designate the same constituent elements in FIG. 4 and their duplicated descriptions are omitted for the sake of simplicity.

Photocoupler 108, second power supply circuit 109, rectifier circuit 111, transformer 121, and secondary-side main circuit 122 shown in FIG. 1 are not included in switching power supply 4 shown in FIG. 4. Switching power supply 4 shown in FIG. 4 includes a main circuit formed of diode 201, inductor 202 and capacitor 203 added thereto. Switching power supply 4 according to the second embodiment forms a non-isolated_DC-DC converter.

Although operation power is fed from input power supply 2 to second comparator 104, first power supply circuit 103 and driver circuit 101 in FIG. 4, the operation power may be fed from the other power supply with no problem.

As described above, the switching power supply according to the invention facilitates reducing the electric power consumption under a light load, reducing the output voltage variations caused by the load current increasing rapidly from a light load state as much as possible, and reducing the output voltage ringing.

The circuit configuration of a switching power supply according to the invention is not always limited to those shown in FIGS. 1 and 4. For example, burst threshold value Vth1_and power-supply-interruption threshold value Vth2 may be provided with hysteresis characteristics with no problem. A bipolar transistor and an insulated gate bipolar transistor (IGBT) may be used for MOSFET 110. DC power obtained by rectifying and smoothing AC power may be used in substitution for the DC power fed from input power supply 2. A series regulator may be used in substitution for rectifier circuit 111.

Now the hysteresis characteristics preferable for burst threshold value Vth1_and power-supply-interruption threshold value Vth2 will be described below.

The switching is resumed from the stopped state thereof at the time point, at which rising feedback signal Vfb exceeds burst threshold value Vth1 to the higher side. Therefore, by lowering burst threshold value Vth1 a little bit, the resumed switching is prevented from stopping soon. Then, as the output voltage rises due to the switching operation, feedback signal Vfb lowers. As lowering feedback signal Vfb exceeds the a-little-bit-lowered burst threshold value Vth1 to the lower side, the switching is stopped. As the switching is stopped, burst threshold value Vth1 is raised a little bit so that the switching may not be resumed soon.

If feedback signal Vfb causes small variations around burst threshold value Vth1, the switching will repeat stopping and restarting in a short period, causing an oscillation. For preventing the oscillation from causing, first reference voltage supply 106 and second reference voltage supply 107 are provide with the hysteresis characteristics as described above. The hysteresis characteristics prevent audible sounds from causing from the transformer and widen the burst period for reducing the standby energy. Since feedback signal Vfb is accompanied usually by noises, the hysteresis characteristics also work for preventing malfunctions caused by the noises from occurring. The same holds for Vth2. Having the hysteresis characteristics, the control power operate alternating between on and off, and that wasted power is reduced.

Moreover, power supply circuit 103 in FIGS. 1 and 4 may be configured by a simple switching circuit with no problem. The switching circuit may be opened by the output from second comparator circuit 104 with no problem, as feedback signal Vfb exceeds power-supply-interruption threshold voltage Vth2 to the lower side. The switching circuit may be closed by the output from second comparator circuit 104 with no problem, as feedback signal Vfb exceeds power-supply-interruption threshold value Vth2 to the higher side. By obtaining the voltages necessary for operating the constituent elements of the switching power supply directly from input power supply 2, rectifier circuit 111 may be omitted.

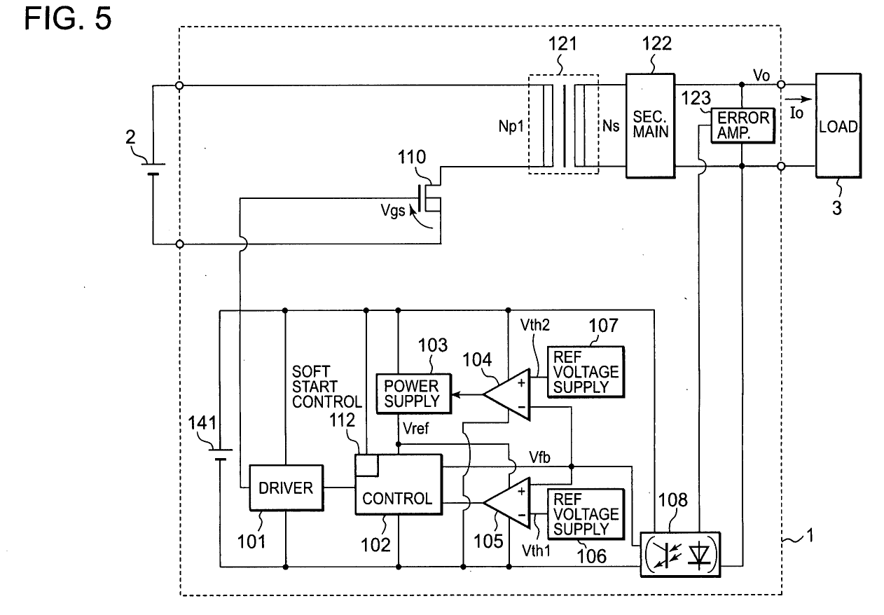

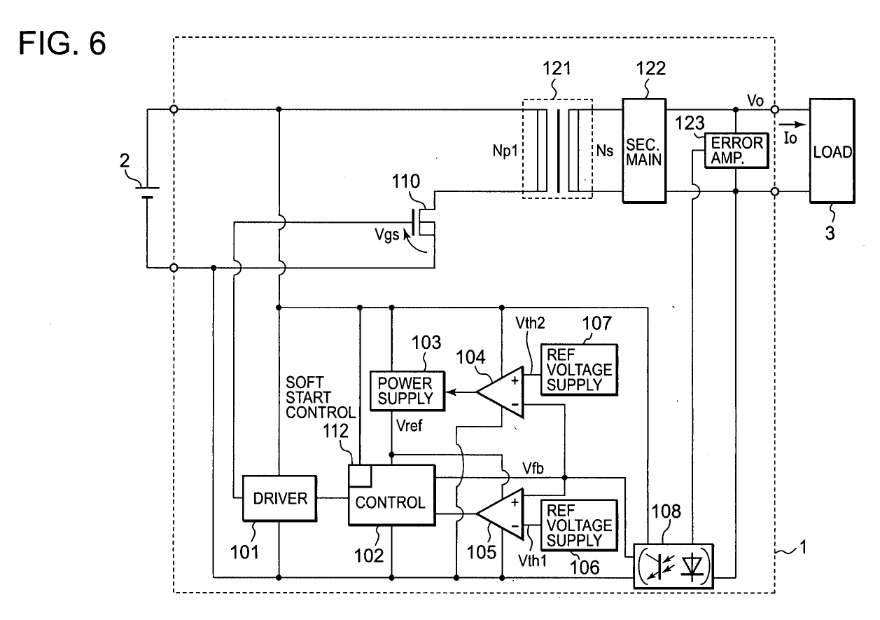

FIG. 5 is a block diagram of a switching power supply according to a third embodiment of the invention. The switching power supply shown in FIG. 5 is a modification of the switching power supply shown in FIG. 1.

As shown in FIG. 5, rectifier circuit 111 shown in FIG. 1 is omitted and DC power supply 141 is employed in substitution for rectifier circuit 111. DC power supply 141 is employed for a control power supply. The configuration described above prevents the problems as described in the paragraph [0019] from causing and facilitates omitting second power supply circuit 109.

When the voltage of input power supply 2 is as high as to be employable for the control power without boosting nor bucking, rectifier circuit 111 and second power supply circuit 109 may be omitted by employing the structure, in which the power from input power supply 2 is used directly for control power.

What is claimed is:

1. A switching power supply of an isolated type, the switching power supply generating a stabilized DC output from a DC output of a DC power supply, the switching power supply comprising:
an error amplifier for amplifying an error between a voltage of the stabilized DC output and a preset voltage;
a signal transmitter for isolating an output signal from the error amplifier for forming a feedback signal, the signal transmitter transmitting the feedback signal to a control circuit; and
a control power supply for supplying power to a control circuit, the control circuit including
a main switching device,
a control section for controlling ON and OFF switching of the main switching device in response to the feedback signal,
a driver section for driving the main switching device in response to an output from the control section and stopping the driving when the first comparator section detects the feedback signal decreasing below the first reference voltage value,
a first comparator section for comparing the feedback signal with a first reference voltage value,
a second comparator section for comparing the feedback signal with a second reference voltage value lower than the first reference voltage value, and
a first power supply section supplied with operation power from the control power supply, the first power supply section feeding operation power to a constituent element in the control section and stopping the feeding the operation power when the second comparator section detects the feedback signal decreasing below the second reference voltage value.

2. A switching power supply of a non-isolated type, the switching power supply generating a stabilized DC output from a DC output of a DC power supply, the switching power supply comprising:
an error amplifier for amplifying an error between a voltage of the stabilized DC output and a preset voltage, and outputting the amplified error to a control circuit as a feedback signal; and
a control power supply for supplying power to the control circuit,
the control circuit including
a main switching device,
a control section for controlling ON and OFF switching of the main switching device in response to the feedback signal,
a driver section for driving the main switching device in response to an output from the control section and stopping the driving when the first comparator section detects the feedback signal decreasing below the first reference voltage value,
a first comparator section for comparing the feedback signal with a first reference voltage value,
a second comparator section for comparing the feedback signal with a second reference voltage value lower than the first reference voltage value,
a first power supply section supplied with operation power from the control power supply, the first power supply section feeding operation power to a constituent element in the control section and stopping the feeding the operation power when the second comparator section detects the feedback signal decreasing below the second reference voltage value.

3. The switching power supply according to claim 1, the switching power supply further comprising a second power supply section that feeds the operation power to the signal transmitter.

4. The switching power supply according to claim 1, wherein the first power supply section feeds the operation power to the first comparator section.

5. The switching power supply according to claim 1, wherein the control section further includes a soft start control circuit supplied with the operation power from the control power supply, and that operates only when DC power is supplied at or before startup to the switching power supply.

6. The switching power supply according to claim 2, wherein the first power supply section feeds the operation power to the first comparator section.

7. The switching power supply according to claim 2, wherein the control section further includes a soft start control circuit supplied with the operation power from the control power supply, and that operates only when DC power is supplied at or before startup to the switching power supply.
